(19) United States
(12) Patent Application Publication
(10) Pub. No.: US 2005/0219355 A1
(43) Pub. Date: Oct. 6, 2005

(54) Information input device

(76) Inventors: Kazushi Tahara, Tokyo (JP); Takae Wakabayashi, Tokyo (JP); Kiichiro Shinokura, Tokyo (JP)

Correspondence Address: ARENT FOX PLLC, 1050 CONNECTICUT AVENUE, N.W., SUITE 400, WASHINGTON, DC, 20036, US

(21) Appl. No.: 11/094,486

(22) Filed: Mar. 31, 2005

(30) Foreign Application Priority Data
Mar. 31, 2004 (JP) JP2004-102591

(51) Int. Cl. H04N 7/14; H04N 1/40

(52) U.S. Cl. 348/14.05

(57) ABSTRACT

An information input device which has portability for the sake of improved operation flexibility, and has high operational resolution as well. The information input device comprises: two plate-like input members capable of being slid against each other, being held between fingertips or part of two fingers of one hand; a holding part to be held with other fingers of the one hand; connecting parts for connecting the two plate-like input members to the holding part; and an information creating part for creating input information in accordance with a relative position or relative movement between the plate-like input members.

### BACKGROUND OF THE INVENTION

The invention relates to an information input device.

The present application claims priority from Japanese Application No. 2004-102591, the disclosure of which is incorporated herein by reference.

With the diversification of functions of audiovisual equipment, electric household appliances, industrial apparatuses, computers, and the like, the amounts of information to be input thereto have been increasing. Information input devices have become complicated accordingly, with deterioration in human friendliness. For example, a remote controller of a TV set is provided with a number of buttons, and each single button is assigned for several functions depending on mode switching, which makes it harder to understand.

Some information devices utilize graphical user interfaces (GUIs), whereas they are not always easy to use. Besides, appropriate information input devices (such as a pointing device) that have operational resolution comparable to the high resolution of display units have not yet been in practical use.

Take, for example, a mouse which is a typical pointing device for PCs and the like. It requires a certain area of plate-like space such as a tabletop for operation, and cannot be operated freely if it is held in hand. Moreover, due to wrist and elbow operations, the mouse is difficult to operate delicately and thus is far from being an information input device of high operational resolution. A portable PC is often equipped with an information input device of touch panel type. The panel itself is fixed to the PC, however, and thus is poor in operation flexibility. In addition, since the touch-panel type device detects the position of as large an object as a finger (here, the term “finger” also means a thumb), the operational resolution is extremely poor. The feeling of friction at the fingertip might also be unpleasant.

Under such circumstances, there have been proposed various types of information input devices which have high operation flexibility and can be operated with fingertips while the bodies of the devices are held in hand.

For example, description can now be given to explain a prior art disclosed in the publication of Japanese Utility Model Registration No. 3080102 with reference to FIG. 1. The disclosed wireless input device has a body J1, a transmission unit J2, a stick J3, and click buttons J4, J5 which are attached thereto. The transmission unit J2 is intended to transmit PC operation data. The stick J3 is arranged at a position where input operations can be performed thereon with a finger.

Generally , highest operational resolution among those of human operations can result from fingertips. In the foregoing disclosed prior art, however, the device main body is held and fixed in hand and operations are performed by single one finger. As a result, it is impossible to make full use of the fine resolution of fingertips.

More specifically, in the foregoing prior art, the top of the stick J3 is put in contact with the side of the thumb, and the first and second joints of the thumb are bent or stretched for input operations. In fact, it is rather difficult to move a single finger thus alone for operation, and it is even impossible for persons of dexterous hands to obtain high operational resolution through such single-fingered operations.

In conclusion, the above-discussed prior art does provide portability for the sake of improved operation flexibility. However, in view of such applications as a GUI pointing device, it has the problem that fine position inputs cannot be made since it is impossible to obtain high operational resolution corresponding to a high-resolution or wide display screen. Another problem consists in that a single input unit (such as a stick) cannot be operated with resolution as high as required for a number of types of information inputs, so that the types of information to input have to be reduced.

### SUMMARY OF THE INVENTION

The present invention has been achieved to address the foregoing problems. It is thus an object of the present invention to provide an information input device which has portability for the sake of improved operation flexibility, and has high operational resolution as well. For example, when the device is used as a GUI input device, fine positional inputs can be made on a high-resolution or wide display screen. A number of types of information can also be input through simple operations on the input part of the device.

To achieve the foregoing object, the information input device of the present invention comprises at least the configuration according to the following aspect.

That is, according to one of the aspects of the present invention , the information input device comprises: two plate-like input members adapted to be held between fingertips or part of two fingers of one hand and capable of sliding against each other; a holding part to be held with other fingers of the one hand; a connecting part for connecting the two plate-like input members to the holding part; and an information creating part for creating input information at least in accordance with a relative position or relative movement between the plate-like input members.

### BRIEF DESCRIPTION OF THE DRAWINGS

These and other objects and advantages of the present invention will become clear from the following description with reference to the accompanying drawings, wherein:

FIG. 1 is an explanatory view showing a conventional technique;

FIGS. 2A to 2C are explanatory view showing an information input device according to an embodiment of the present invention, FIG. 2A being a general view, FIG. 2B an explanatory view showing a state of operation, and FIG. 2C a sectional view of plate-like input members;

FIG. 3 is an explanatory view showing an information input device according to another embodiment of the present invention (a specific example as to the configuration of connecting parts);

FIG. 4 is an explanatory view showing an information input device according to another embodiment of the present invention (a specific example as to the configuration of the connecting parts);

FIGS. 5A and 5B are explanatory views showing the information input device according to the another embodiment of the present invention (the specific example as to the configuration of the connecting parts);

FIGS. 6A to 6C are explanatory views showing an information input device according to another embodiment of the present invention (a specific example as to the configuration of the connecting parts);

FIGS. 7A to 7D are explanatory views showing an example of an information creating part according to an embodiment of the present invention (a practical example of relative displacement detection using moiré fringes);

FIGS. 8A to 8C are explanatory views showing an example of the information creating part according to the embodiment of the present invention (a practical example of pressure detecting means);

FIG. 9 is an explanatory view showing an example of the information creating part according to the embodiment of the present invention (a practical example of tilt detecting means);

FIGS. 10A and 10B are explanatory views showing the example of the information creating part according to the embodiment of the present invention (the practical example of the tilt detecting means);

FIG. 11 is an explanatory view showing an example of the information creating part according to the embodiment of the present invention (a practical example using a rotating ring);

FIG. 12 is an explanatory view showing an example of the information creating part according to the embodiment of the present invention (an application example using various sensors); and

FIG. 13 is an explanatory view showing a practical example in which a holding part is equipped with various accessories.

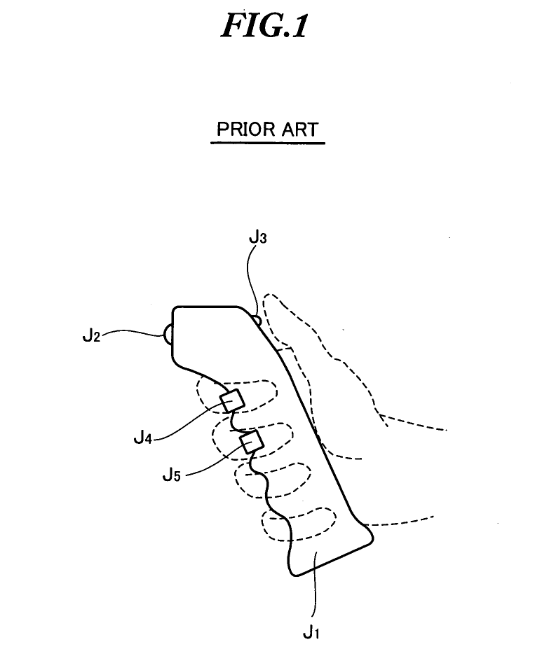

### DETAILED DESCRIPTION OF THE PREFERRED EMBODIMENTS

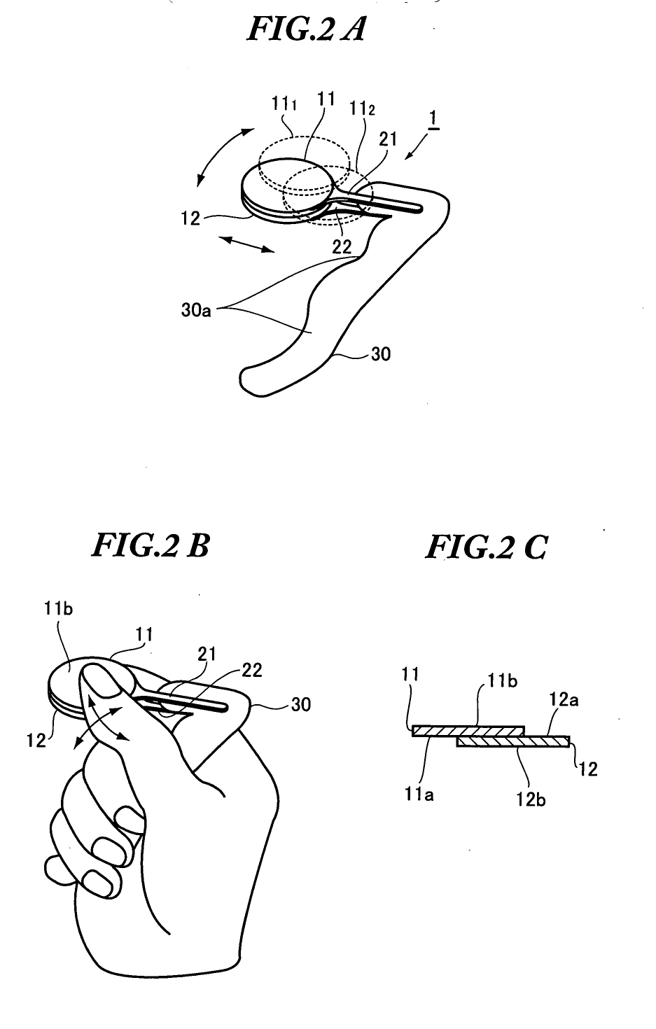

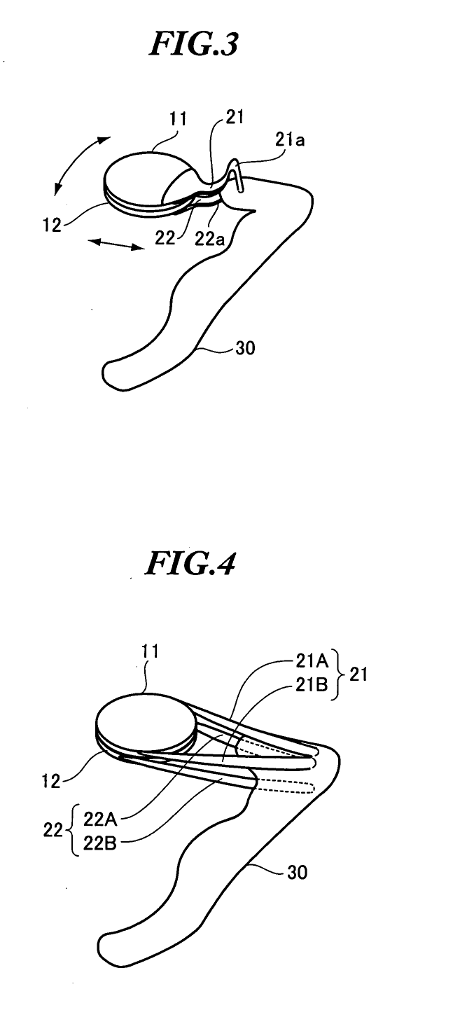

Hereinafter, embodiments of the present invention will be described with reference to the drawings. FIGS. 2A to 2C are explanatory views showing an information input device according to an embodiment of the present invention. More specifically, FIG. 2A is a general view of the information input device, FIG. 2B an explanatory view showing a state of operation, and FIG. 3C a sectional view of plate-like input members.

The information input device according to the embodiment of the present invention utilizes the following facts. That is, highest resolution results from fingertip operations among all human operations. Besides, when one holds an object between fingertips or part of fingers, he/she can easily concentrate attention on the fingertips or part of fingers in particular. As a result, the object can be moved readily at the person's will. The operations of holding an object between two fingertips or part of fingers of one hand (such as the fingertip of a thumb and the top portion of a forefinger ahead of the second joint) and sliding them against each other are thus utilized for input operations on the information input device.

As shown in FIGS. 2A and 2B, the information input device 1 according to the embodiment of the present invention comprises two plate-like input members 11 and 12, a holding part 30, connecting parts 21 and 22, and an information creating part (not shown). The plate-like input members 11 and 12 can be slid against each other, being held between two fingertips or part of fingers of one hand. The holding part 30 is held with other fingers of the one hand. The connecting parts 21 and 22 connect the two plate-like input members 11 and 12 to the holding part 30. The information creating part creates input information in accordance with a relative position or relative movement between the plate-like input members 11 and 12.

According to the information input device 1 having such a basic configuration, the device itself is held by one hand at the holding part 30. This provides the advantages of improved operation flexibility and improved operability. Moreover, since the plate-like input members 11 and 12 are held and slid against each other between the fingertips or part of two fingers, the two plate-like input members 11 and 12 can be relatively slid in any directions including the directions of the arrows in FIG. 2A (for example, one plate-like input member 11 can be relatively slid against the other plate-like input member 12 as shown by the reference numerals 111 and 112). Such operations between two fingers make it possible to utilize the sliding operations of fingertips which are the highest in operational resolution among all human operations. In addition, the input operations can be made in such a state that one can easily concentrate attention on the fingertips for high sensitivities.

According to the relative position or relative movement between the plate-like input members resulting from such input operations, the information creating part then creates input information. The provision of this information creating part allows, for example, fine position inputs on a high-resolution or wide display screen even when the information input device 1 is used as a GUI input device. When the input operations are divided into sub units to input respective different types of information, a number of types of information can be input through input operations as simple as sliding fingers against each other.

As shown in FIGS. 2B and 2C, the two plate-like input members 11 and 12 have slidable contact faces 11a and 12a opposed to each other, and contact faces 11b and 12b on the respective backsides. The contact faces 11b and 12b are intended for contact with the foregoing fingertips or part of fingers. One contact face 11b is configured so as to be capable of contact with the side of a thumb. The contact faces 11b and 12b are provided with friction faces for avoiding a slip on the fingertips or part of fingers when necessary.

According to such a configuration, highly sensitive operations of sliding the side of a thumb and part of another finger against each other (the operations of moving the thumb relatively against the other finger as shown by the arrows of FIG. 2B) can be made with the two plate-like input members 11 and 12 interposed therebetween. In particular, when the anti-slip friction faces are formed on the contact faces 11b and 12b, the input operations can be made with the same sense of feeling as if the fingers are actually slid against each other Moreover, a high-viscosity liquid such as grease can be put between the slidable contact faces 11a and 12b for smoother sliding and some sense of response, thereby allowing operations of still higher sensitivity. While the two fingers used in the example shown in FIG. 2B are a thumb and a forefinger, they are not limited thereto. For example, the plate-like input members 11 and 12 may be held between a thumb and a middle finger so that the forefinger is used for other input operations or the like.

Description will now be given of the connecting parts 21 and 22 of the information input device 1 according to the embodiment of the present invention. The connecting parts 21 and 22 are intended to connect the two plate-like input members 11 and 12 to the holding part 30 so as to be capable of relative sliding. These connecting parts 21 and 22 may be configured so that they have flexibility or elasticity and hold the two plate-like input members 11 and 12 inseparably.

In this case, the two plate-like input members 11 and 12 can be relatively slid freely or under a desired restriction. Besides, even when the two fingers holding the plate-like input members 11 and 12 are released, the two plate-like input members 11 and 12 will not come apart. This makes it possible to resume input operations immediately even after the two fingers are taken off the plate-like input members 11 and 12, allowing high operability.

The connecting parts 21 and 22 may also be configured so that the two plate-like input members 11 and 12 are retained at positions capable of being held between two fingers when the holding part 30 is held by one hand. This facilitates operations since it is possible to grip the holding part 30 by one hand and hold the plate-like input members 11 and 12 between two fingers while putting the hand in its natural gripping state. In addition, even after the two fingers holding the plate-like input members 11 and 12 are released, with the holding part 30 gripped, it is possible to resume input operations immediately as mentioned above. It is therefore possible to obtain high operability.

The connecting parts 21 and 22 may be provided with a shape restoring function of restoring the two plate-like input members 11 and 12 to their neutral positions when they are not held. This facilitates the operations of sliding the plate-like input members 11 and 12 right and left or up and down continuously, with an improvement in operability. This also provides the advantage that input information can be initialized easily.

To be more specific, the connecting parts 21 and 22 may be made of bar-like or plate-like elastic members having a desired elasticity and an appropriate flexibility, such as rubber. The sectional configuration of the bar-like or plate-like elastic members can be devised to provide the shape restoring function.

FIGS. 3 to 6C show specific examples of configuration of the connecting parts 21 and 22 (the same portions as in the foregoing description will be designated by identical reference numerals, and overlapping description thereof will be omitted). In the example of FIG. 3, the plate-like elastic connecting parts 21 and 22 having a rib structure are provided with bends 21a and 22a. In this example, the connecting parts 21 and 22 are bent at the bends 21a and 22a when not in operation (when not being held). The plate-like input members 11 and 12 can be slid by operating the connecting parts 21 and 22 to extend. The shape restoring function toward the bent state provides high operability as described above.

In FIG. 4, the connecting part 21 for holding the plate-like input member 11 is composed of two bar-like elastic members 21A and 21B. The connecting part 22 for holding the plate-like input member 12 is also composed of two bar-like elastic members 22A and 22B.

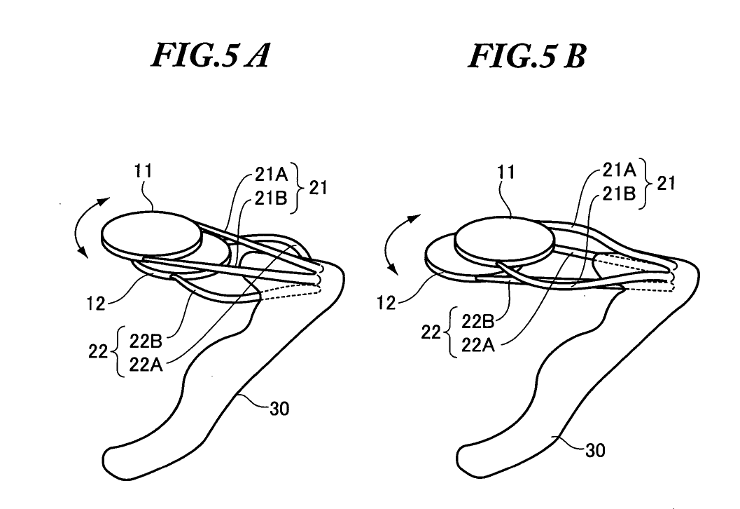

FIGS. 5A and 5B show the states of operation thereof. At least one of the bar-like elastic members 21A to 22B is elastically bent when the plate-like input members 11 and 12 are operated to slide against each other. More specifically, as shown in FIG. 5A, the bar-like elastic members 22A and 22B are elastically bent when the plate-like input member 12 is pulled closer. As shown in FIG. 5B, the bar-like elastic members 21A and 21B are elastically bent when the plate-like input member 21 is pulled closer. Moreover, the bar-like elastic members on either the right side or the left side can be bent to swing the plate-like input members 11 and 12 against each other in the directions of the arrows. Since the bar-like elastic members 21A to 22B restore their straight shapes, it is possible to provide the high operability as described above.

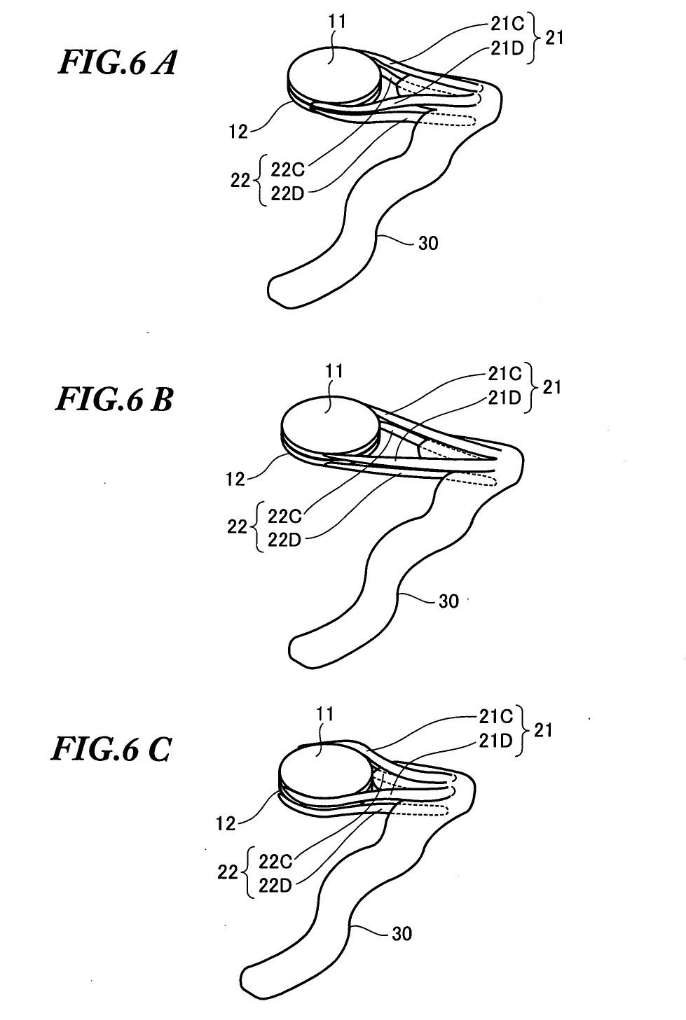

In the example shown in FIGS. 6A to 6C, the connecting parts 21 and 22 are configured to allow multi-step adjustments to the positions of the plate-like input members 11 and 12 with respect to the holding part 30. The connecting parts 21 and 22 are made of a pair of arm members 21C and 21 D and a pair of arm members 22C and 22D, respectively. The arm members 21C and 21D have the function of holding the plate-like input member 11 elastically therebetween, and the arm members 22C and 22D have the function of holding the plate-like input member 12 elastically therebetween. The plate-like input members 11 and 12 can thus be situated to the left (FIG. 6B) of or farther than their center positions (FIG. 6A), or to the right (FIG. 6C) of or closer than the center positions. The arm members 21C, 21D, 22C, and 22D may be bent so that the plate-like input members 11 and 12 are held stably in the state of FIG. 6A, thereby providing a self restoring function toward the center positions.

Consequently, the plate-like input members 11 and 12 can be adjusted to easy-to-operate positions depending on such factors as the lengths of the fingers of the operator. In some configurations, it is even possible to change the input mode according to the distance from the plate-like input members 11 and 12 to the holding part 30.

Hereinafter, description will be given of examples of the information creating part for creating the input information in accordance with the relative position, the relative movement, or the like between the plate-like input members 11 and 12 described above.

One of the examples of the information creating part is relative displacement detecting means (sensor) for detecting a relative displacement between the plate-like input members 11 and 12. When the information input device according to the embodiment of the present invention is used as a GUI input device, it can desirably input position information with precisions of the order of the resolution of currently-prevailing display units (approximately one thousand dots) for the sake of high pointing capability (capability for inputting position information). Meanwhile, the information input device 1 according to the embodiment of the present invention utilizes the relative displacement between fingers, and thus has a rather narrow range of displacement (the narrow range is even desirable in terms of operability). Then, the minimum unit of resolution of the relative displacement between the plate-like input members 11 and 12 can fall to or below 10 micrometers.

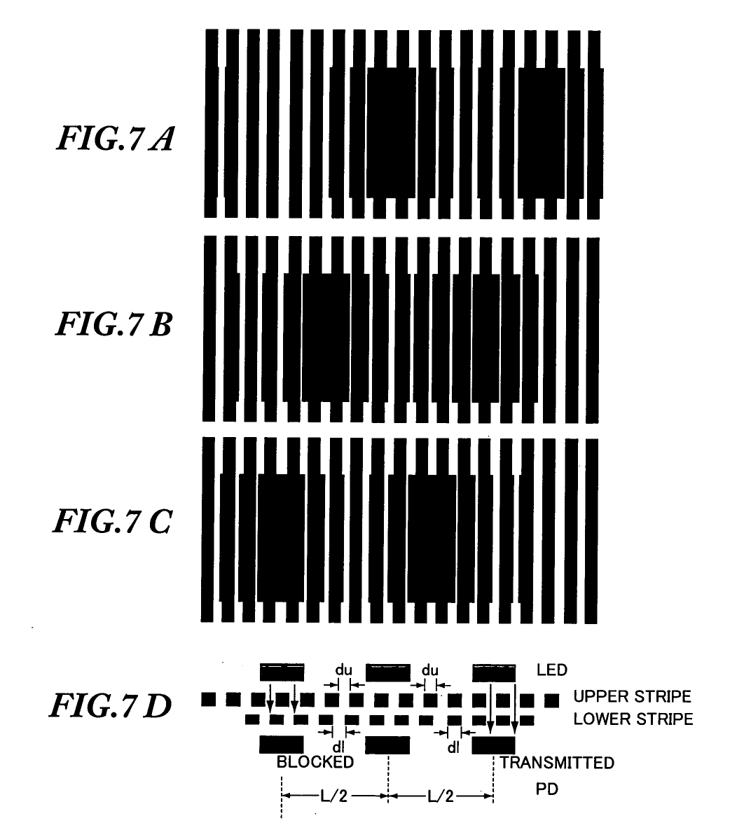

For one of the methods of detecting such a small relative displacement between the two plate-like input members 11 and 12, FIGS. 7A to 7D show an embodiment of relative displacement detection by using moir\acute{e} fringes. As is well known, moir\acute{e} fringes originally refer to a wave pattern occurring from layers of fine meshes such as silk fabric. This phenomenon can be utilized to show minute displacements as changes of the wave pattern in a far greater scale, which is effective for the embodiment of the present invention where fine displacement detection is required.

The relative displacement sensor of this practical example comprises two film-like sheets, each of which has light transmitting areas and light blocking areas alternately in stripes. The sheets are arranged on the targets of the displacement detection, or the slidable contact faces 11a and 12a of the upper and lower plate-like input members 11 and 12, respectively. Light-emitting devices (LEDs) and photodetectors (PDs) are arranged on the inner sides of the upper and lower plate-like input members 11 and 12, respectively (see FIG. 7D; the light transmitting areas are shown in white, and the light blocking areas are in black). In each of the sheets, the transmitting areas and the blocking areas of the stripes have the same width. The stripes on the upper sheet (upper stripes) shall have a width of du, and those on the lower sheet (lower stripes) a width of dl.

Next, description will be given of the operation of this practical example. FIGS. 7A to 7C show the two striped sheets overlapping each other, as viewed from above (the upper and lower sheets are slightly different in stripe width). Here, for the sake of easy understanding, the lower sheet is shown in a smaller height. Since the views are solely intended to visualize the moiré phenomenon, the positional relationship is not consistent with FIG. 7D. Now, when the upper sheet in the state of FIG. 7A moves to the left (in relative terms, the same as if the lower sheet moves to the right) as much as the width of a stripe, the moiré fringes resulting from the overlap change as shown in FIGS. 7B and 7C. For example, in the case of the leftmost photodetector (PD), the light transmitting state (FIG. 7A) shifts to the semi-transmitting state (FIG. 7B), and changes to the blocking state (FIG. 7C). That is, the output current of the photodetector PD decreases gradually from the ON state where a maximum current flows to the OFF state where no current flows. When the upper sheet moves further to the left as much as the stripe width, then the output current changes from the OFF state to the ON state.

Then, the number n of changes of this current (ON to OFF, OFF to ON) can be counted to calculate the distance of displacement as (the stripe width of the sheet)×(the number n of changes of the current). For example, given the stripe width is 10 micrometers, it is possible to detect the amount of displacement in units (precisions) of 10 micrometers.

In order to detect the direction of the movement, right or left, aside from the amount of displacement, three pairs of light-emitting devices (LEDs) and photodetectors (PD) are arranged as shown in FIG. 7D. Here, the state of the PD at the center (either ON state or OFF state) is compared with the states of the PDs on the right and left before a change. Then, the direction of movement, right or left, is determined depending on which PD had the same state. Incidentally, the interval L of the moiré fringes is inversely proportional to a difference between the widths du and dl of the upper and lower stripes, or given by L=du·dl/|du−dl|. The three pairs of photodetectors and light-emitting devices are arranged at half the intervals, or L/2.

The foregoing description has dealt with the detection as to one direction (referred to as X-axis). Similarly, the movement in the orthogonal direction (referred to as Y-axis) can also be detected by arranging the foregoing three pairs of light-emitting devices and photodetectors in the Y-axis direction.

Up to this point, description has been given of the method of detecting a relative displacement by using moiré fringes. The method is not limited to the foregoing one, however, as long as it can detect the relative displacement. For example, a thin film resistor sensor and a magnetic scale may be used as the relative displacement detecting means since they have resolutions and can be formed in a thin sheet.

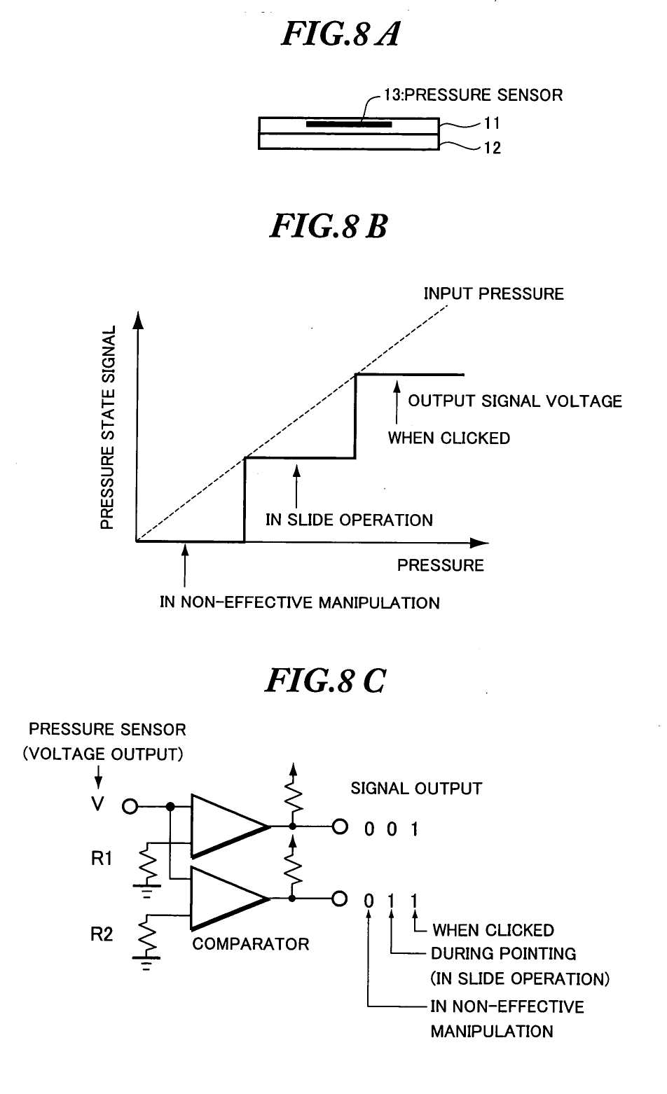

Next, referring to FIGS. 8A to 8C, description will be given of an example where the information creating part is constituted by pressure detecting means (sensor). In the example shown in FIG. 8A, the upper plate-like input member 11 is provided with a pressure sensor 13. In another example, however, the lower plate-like input member 12 may be provided with the pressure sensor 13. Moreover, both the plate-like input members 11 and 12 may be provided with one or even a plurality of sensors each. For the sake of click feeling, spring structures may also be arranged.

One of the purposes of this pressure sensor 13 is to provide a function equivalent to a so-called mouse click (the function of indicating an input at that cursor location). This operation can be effected by applying a finger pressure higher than that for slide operations in a short time.

Moreover, the pressure sensor 13 may be a piezoelectric sensor, for example. In this case, as shown in FIG. 8B, the pressure sensor 13 is provided with the function of detecting an analog voltage signal corresponding to the finger pressure, and discriminating it among three pressure states of “in non-effective manipulation,” “in slide operation,” and “when clicked.” The purpose of this additional function, aside from the click function, is to transmit the signal from the relative displacement detecting means to exterior only when in operation (in slide operation). Here, when a finger is put on the plate-like input member 11, the pressure to slide it and the pressure when in non-effective manipulation are discriminated, and the foregoing signal from the relative displacement detecting means is interrupted when in non-effective manipulation.

FIG. 8C shows an example of the circuit for this purpose. The circuit is composed of resistors R1 and R2, and two comparators. The resistors R1 and R2 can be selected to optimize the discrimination between the pressures of the non-operation state and the slide-operation state, and the discrimination between the pressures of the slide-operation state and the clicked state. ONs and OFFs of the two final outputs are then combined to identify the three states, which can be used for such purposes as the foregoing click detection and the control on the transmission of the relative displacement detection signal. It is understood, however, that such a circuit need not necessarily be used. For example, the output voltage of the pressure sensor may be AD-converted before the three pressure states are discriminated digitally.

The relative displacement detecting means and the pressure detecting means described above can provide a position information inputting function and a click function in terms of mouse functions. In addition, a tilt sensor to be described below may be used to provide the function of distinguishing right and left mouse clicks.

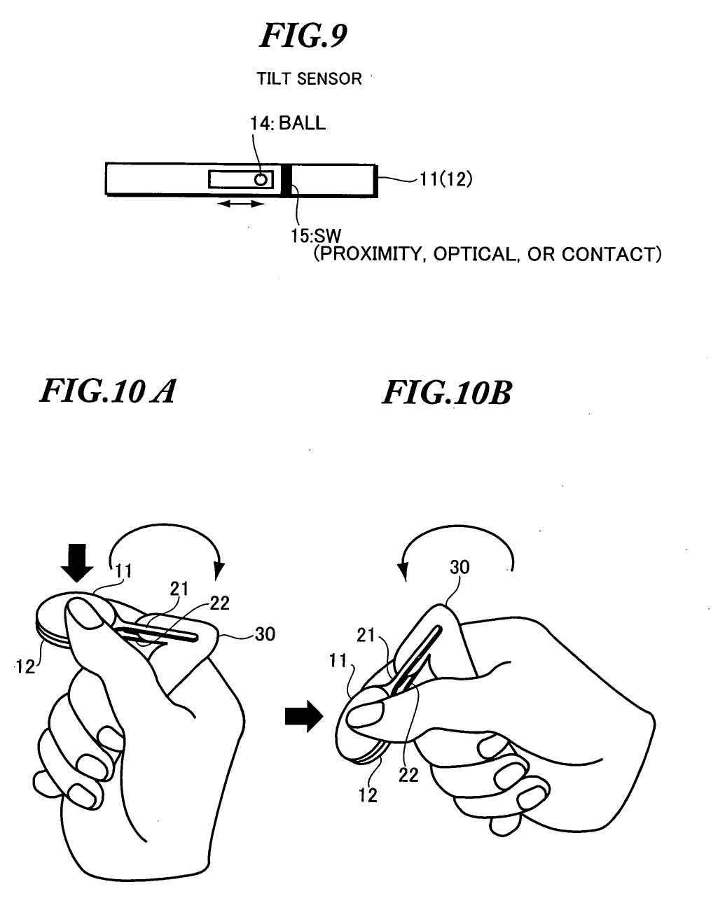

FIGS. 9 to 10B show a practical example with tilt sensing means (sensor) for sensing the tilt of the input members in a certain direction. In this example, the tilt sensor is made of a ball 14 and a switch 15. This switch 15 may be a proximity switch, an optical switch, a contact switch, or the like. The provision of this sensor makes it possible to detect a right or left tilt of the information input device which is held in hand, for example. A tilt signal for indicating the tilt can be combined with the click signal detected by the foregoing pressure sensor at that time, thereby allowing inputs corresponding to so-called right and left clicks of a two-button mouse.

FIGS. 10A and 10B show the input operations. As shown in FIG. 10A, the plate-like input members 11 and 12 are tilted to the right and a click operation (short-time application of a pressure higher than in slide operation) is made to perform a right click. As shown in FIG. 10B, the plate-like input members 11 and 12 are tilted to the left and a click operation is made to perform a left click.

It is understood that two pressure detecting sensors may be arranged, for example, on the right and left of the plate-like input member 11, respectively. Here, a difference between the finger pressures on the right and left sensors can be detected to identify right and left clicks. In another practical example, a plurality of pressure sensors or a large-area pressure sensor having a plurality of detection subareas may be adopted and configured to detect the states of pressures continuously. Then, two-dimensional cursor movements can be controlled depending on the selection of the detection subareas and the pressing force.

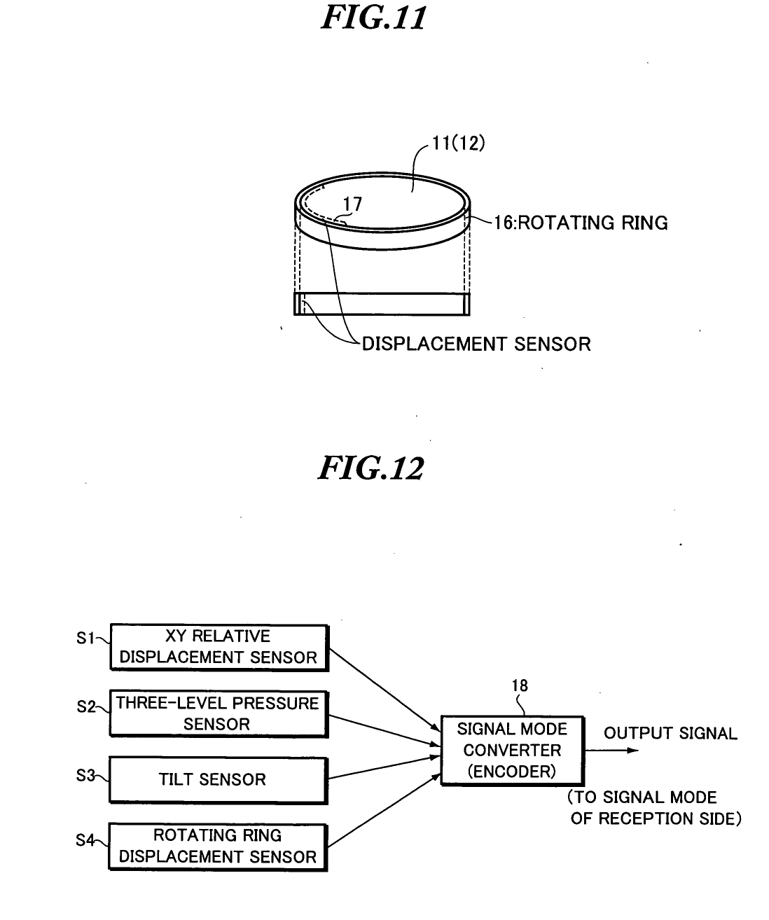

Now, referring to FIG. 11, description will be given of a practical example with a moving member which moves in a one-dimensional fashion. In this example, a rotating ring 16 capable of rotation is arranged around the plate-like input member 11 (12). This rotating ring 16 is configured so that it can rotate around this plate-like 15 input member 11 (12), and a one-dimensional displacement sensor 17 for detecting a relative displacement between this rotating ring 16 and the plate-like input member 11 (12) is interposed therebetween. The rotational displacement of the rotating ring 16 is thus detected, and a signal corresponding to the rotational displacement is output. That is, since this rotating ring 16 can be adjusted in position to output the corresponding signal to exterior, it can play the role of such units as a volume control of a target device and a center roller of a mouse.

FIG. 12 is a block diagram showing how detection signals from the various sensors described above (S1 to S4) are integrated by a signal mode converter (encoder IC) 18, converted into a signal output suitable for the signal mode of the target of the information input device (such as USB signal), and output to exterior.

As has been described, in the information input device accord to the embodiments of the present invention, the information creating part is not limited to the configuration of the foregoing examples but may employ various configurations. The embodiments of the present invention, irrespective of the configuration of the information creating part, comprise the following components: the two plate-like input member 11 and 12 capable of being slid against each other, being held between fingertips or part of fingers of one hand; the holding part 30 to be held with other fingers of the one hand; and the connecting parts 21 and 22 for connecting the plate-like input members 11 and 12 to the holding part 30. Here, what is characteristic is that the input information is created at least in accordance with the relative position or relative movement between the plate-like input members 11 and 12. Consequently, the embodiments of the present invention provide portability for improved operation flexibility, and utilize the keen senses and excellent resolution of human fingers to allow fine position inputs. Various types of information can also be input through simple operations on the input members.

Incidentally, the information creating part may be driven by such an energy source as a battery (including a solar battery) which is arranged in either one or both of the plate-like input members 11 and 12. Otherwise, an energy source may be arranged in the holding part 30 so that the information creating part is driven via the connecting parts 21 and 22 if they are conducive or wired inside.

Description will now be given of the holding part 30. As shown in FIGS. 2A and 2B, the holding part 30 is made of a bar-like member having a length capable of being held in the palm of one hand. A grip (a portion patterned to the shapes of fingers) 30a may be formed if necessary. Then, the connecting parts 21 and 22 are arranged on one end, so that the plate-like input members 11 and 12 can be operated with two fingers (for example, a thumb and a forefinger) with the holding part 30 gripped by one hand as shown in FIG. 2B.

When the holding part 30 is arranged thus, it can contain a battery or other energy sources, and such electric circuits as a radio or optical wireless transmitter for transmitting signals to the target device of the information input as described above.

Moreover, the holding part 30 can be gripped to hold the plate-like input member 11 and 12 at a certain position, so that the directions of movement of the plate-like input members 11 and 12 can be recognized easily. This also yields the advantage of higher operation stability.

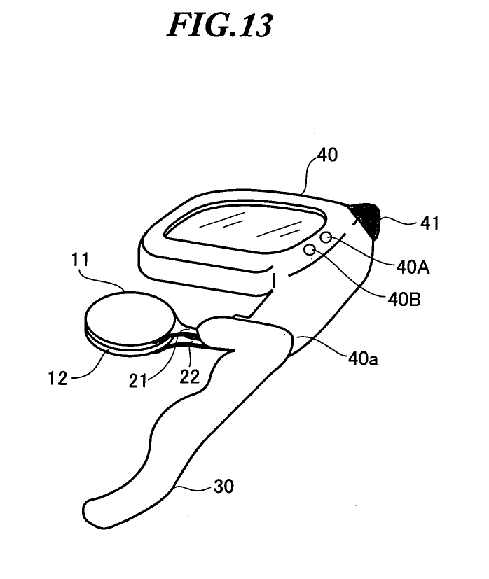

As shown in FIG. 13, the holding part 30 may also be equipped with various accessories. In the shown example, a small-sized display unit 40 is attached to the holding part 30. Here, the display unit 40 is provided with a signal transmission unit 41 and auxiliary indicator devices 40A and 40B. The display unit 40 is configured so as to be detachably attached to the holding part 30 via its connector part 40a. With this display unit 40, it is possible to concentrate attention on the hand alone even during GUI operations, for example. This produces such advantages as improved operability and higher operation accuracies. Besides, in the cases of inputting information to instruments having no display unit on themselves, such as an air conditioner, this display unit 40 can be utilized to show operation menus for information input. Moreover, when the information input device is used as a controller of a TV set or an image recording and reproducing apparatus, it is possible to perform a program selection, a recording preset, and other operations without showing operation menus on the screen of the apparatus itself. This makes it possible to input information without disturbing the current program.

As has been described, according to the information input devices of the embodiments of the present invention, it is possible to provide an information input device which has portability for the sake of improved operation flexibility, and has high operational resolution as well. It is also possible to provide an information input device which allows fine position inputs on a high-resolution or wide display screen when used as a GUI input device in particular. Moreover, the information input device, when used as other input devices, can input various types of information through simple operations.

Another effect of the present invention consists in that relative movements between fingers, which are delicate and high in operational resolution, can sensed by the sensors having sufficient position sensitivities so that both large movements and small movements can be smoothly converted into information for output. Moreover, since the detecting functions corresponding to several types of operations including fingertip operations and wrist operations are available, a number of types of information can be input without switching devices.

Furthermore, the provision of the holding part 30 allows stable operations. Since the holding part 30 is held in hand and the plate-like input members 11 and 12 are operated with relative movements between fingers, it is possible to sense the current position without visually checking it. Consequently, in such cases as a GUI input, the operability improves significantly since eye movements to the hand become unnecessary.

While there has been described what are at present considered to be preferred embodiments of the present invention, it will be understood that various modifications may be made thereto, and it is intended that the appended claims cover all such modifications as fall within the true spirit and scope of the invention.

1. An information input device comprising:
two plate-like input members adapted to be held between fingertips or part of two fingers of one hand and capable of sliding against each other;
a holding part to be held with other fingers of the one hand;
a connecting part for connecting the two plate-like input members to the holding part; and
an information creating part for creating input information at least in accordance with a relative position or relative movement between the plate-like input members.

2. The information input device according to claim 1, wherein:
the two plate-like input members have slidable contact faces opposed to each other, and contact faces on respective backsides for the fingertips or part of fingers to make contact with; and
one of the contact faces of the plate-like input members is capable of making contact with a side of a thumb.

3. The information input device according to claim 2, wherein
friction faces for preventing a slip on the fingertips or part of fingers are formed on the contact faces.

4. The information input device according to claim 1, wherein
the connecting part has flexibility or elasticity, and holds the two plate-like input members inseparably.

5. The information input device according to claim 1, wherein
the connecting part retains the two plate-like input members at such positions that they can be held between the two fingers with the holding part held in the one hand.

6. The information input device according to claim 1, wherein
the connecting part has a shape restoring function of restoring the two plate-like input members to their neutral positions when they are not held.

7. The information input device according to claim 1, wherein
the information creating part creates the input information in accordance with a relative movement between the two plate-like input members along a certain plane.

8. The information input device according to claim 1, wherein
the information creating part has pressure detecting means for detecting a pressing force applied on the plate-like input members, and creates the input information in accordance with an output of the pressure detecting means.

9. The information input device according to claim 8, wherein
the pressure detecting means creates the input information in accordance with a level of pressurization on the plate-like input members.

10. The information input device according to claim 1, wherein
the information creating part has tilt detecting means for detecting a tilt of the plate-like input members, and creates the input information in accordance with an output of the tilt detecting means.

11. The information input device according to claim 1, wherein
the information creating part has a rotating ring for rotating around an outer periphery of the plate-like input members, and detecting means for detecting a relative rotation of the rotating ring with respect to the plate-like input members, and creates the input information in accordance with an output of the detecting means.

12. The information input device according to claim 3, wherein
the connecting part has flexibility or elasticity, and holds the two plate-like input members inseparably.

13. The information input device according to claim 4, wherein
the connecting part retains the two plate-like input members at such positions that they can be held between the two fingers with the holding part held in the one hand.

14. The information input device according to claim 5, wherein
the connecting part has a shape restoring function of restoring the two plate-like input members to their neutral positions when they are not held.

15. The information input device according to claim 6, wherein
the information creating part creates the input information in accordance with a relative movement between the two plate-like input members along a certain plane.

16. The information input device according to claim 7, wherein
the information creating part has pressure detecting means for detecting a pressing force applied on the plate-like input members, and creates the input information in accordance with an output of the pressure detecting means.

17. The information input device according to claim 16, wherein
the pressure detecting means creates the input information in accordance with a level of pressurization on the plate-like input members.

18. The information input device according to claim 9, wherein
the information creating part has tilt detecting means for detecting a tilt of the plate-like input members, and creates the input information in accordance with an output of the tilt detecting means.

19. The information input device according to claim 10, wherein
the information creating part has a rotating ring for rotating around an outer periphery of the plate-like input members, and detecting means for detecting a relative rotation of the rotating ring with respect to the plate-like input members, and creates the input information in accordance with an output of the detecting means.
